(19) United States
(12) Patent Application Publication
(10) Pub. No.: US 2019/0211731 A1
(43) Pub. Date: Jul. 11, 2019

(54) CATALYST SUBSTRATES

(71) Applicant: BASF Corporation, Florham Park, NJ (US)

(72) Inventors: Jianjun He, Guangxi (CN); Shuiping Deng, Guangxi (CN); Gengsheng Chu, Guangxi (CN); Mike Galligan, Cranford, NJ (US); Ye Liu, Holmdel, NJ (US)

(21) Appl. No.: 16/332,298

(22) PCT Filed: Sep. 23, 2016
(86) PCT No.: PCT/CN2016/099844

§ 371 Date: Mar. 11, 2019

(51) Int. Cl. F01N 3/28; B01J 35/04

(52) U.S. Cl. CPC F01N 3/2821; B01J 35/04; F01N 3/2814; F01N 2330/04; F01N 2330/40; F01N 2330/323; F01N 2330/324; F01N 2330/38; F01N 2330/322

(57) ABSTRACT

Provided are metal foil matrices formed of corrugated metal foil with oblique angles. The metal foil matrices are capable of providing turbulent gas flow there through. The matrices may contain a catalytic coating. The matrices may be employed in a catalytic converter for treatment of exhaust gas emissions of an internal combustion engine.

This invention relates to certain metal matrices containing skewed channels and methods of making them. The invention also relates to substrates comprising the metal matrices. The substrates and matrices described herein may be used in catalytic converters for use with vehicular engines to control exhaust emissions.

### BACKGROUND

Typically, substrates used in catalytic converter applications have straight-through channels, which lead to laminar flow rather than turbulent flow. These commonly used substrates cause the following three main problems when used as catalyst substrates: a) lower catalytic conversion rates as a result of the laminar flow; b) high foil consumption resulting in increased manufacturing costs; and/or c) weak mechanical strength when tested in the Hot Shake Test, the Hot Cycling Test and combinations of these tests, cold vibration testing, water quench testing and impact testing in engine emission control applications.

The Hot Shake test involves oscillating (50 to 200 Hertz and 28 to 80 G inertial loading) the device in a vertical, radial or angular attitude at a high temperature (between 800 and 1050° C.; 1472 to 1922° F., respectively) with exhaust gas from a gas burner or a running internal combustion engine simultaneously passing through the device. If the device telescopes, or displays separation or folding over of the leading or upstream edges of the foil leaves or shows other mechanical deformation or breakage up to a predetermined time, e.g., 5 to 200 hours, the device is said to fail the test.

The Hot Cycling Test is run with exhaust flowing at 800 to 1050° C.; (1472 to 1922° F.) and cycled to 120 to 200° C. once every 13 to 20 minutes for up to 300 hours. Telescoping or separation of the leading edges of the thin metal foil strips or mechanical deformation, cracking or breakage is considered a failure.

The Hot Shake Test and the Hot Cycling Test are sometimes combined, that is, the two tests are conducted simultaneously or superimposed one on the other.

There is still a need in the art for catalyst substrates for catalytic converter applications

1) to reduce consumption of materials required to construct the substrates;

2) to provide cost savings in making the substrate;

3) to improve the conversion rate(s) of the catalytic converter(s) without increasing the dimensions of the catalytic converter(s);

4) to lower the platinum group metal (PGM) loading; and

5) to provide a substrate that has increased strength and can resist the Hot Shake Test, the Hot Cycling Test and the combinations of these tests, cold vibration testing, water quench testing and impact testing in engine emission control applications.

### SUMMARY

Accordingly, disclosed is a metal foil matrix comprising a plurality of metal foil layers each having oblique angle corrugation.

Also disclosed is a catalyst substrate comprising a jacket tube and a present metal foil matrix in an interior thereof.

Also disclosed is method of making a present catalyst substrate, the method comprising

a) providing a metal foil strip with oblique angle corrugation;

b) winding, coiling or folding the metal foil strip to form a matrix comprising a plurality of metal foil layers;

c) inserting the matrix into a jacket tube; and

d) joining the periphery of the matrix to the jacket tube interior.

### BRIEF DESCRIPTION OF THE DRAWINGS

FIG. 1A shows a reference substrate design with secluding foils.

FIG. 1B shows a mutation of a reference design also with secluding foils.

FIG. 1C shows another reference design which fails to form channels.

FIG. 1D shows a present channel matrix capable of providing turbulent flow.

FIGS. 2A, 2B, 2C and 2D show possible shapes/angles of oblique angle corrugation of the channel matrices of the invention.

FIGS. 3A, 3B and 3C show possible shapes/angles of the oblique angle corrugation of the channel matrices of the invention.

FIG. 4 shows that a skewed channel substrate has less back pressure (flow resistance) than a reference (common).

FIG. 5 shows that a skewed channel substrate catalyst has higher conversion (less emission) than a reference (common).

FIG. 6 shows that a skewed channel substrate catalyst has higher conversion (less emission) than the reference (common).

FIGS. 7A, 7B, 7C, 7D, 7E and 7F show that a skewed channel substrate of the present invention is more mechanically durable than a common.

FIG. 8 shows how a skewed channel substrate is wound.

FIG. 9 shows a skewed channel matrix in a mantle or jacket tube.

### DETAILED DESCRIPTION

A metal foil matrix refers to a matrix comprising a metal foil strip with oblique angle corrugation. “Oblique” means “not straight”. Thus, an oblique angle is an acute or obtuse angle, that is not a right angle or a multiple of a right angle.

The metal foil matrix is suitably inserted into a jacket tube to form a catalyst substrate or a “skewed catalyst substrate”. The periphery of the matrix may be joined with the jacket tube interior to obtain the skewed channel substrate. The jacket tube may comprise metal or metal alloy.

“Cells” refer to the spaces formed in the skewed channel matrix by the winding, coiling or folding of corrugated metal foil sheets, wherein these spaces extend between opposite ends of the skewed channel matrix.

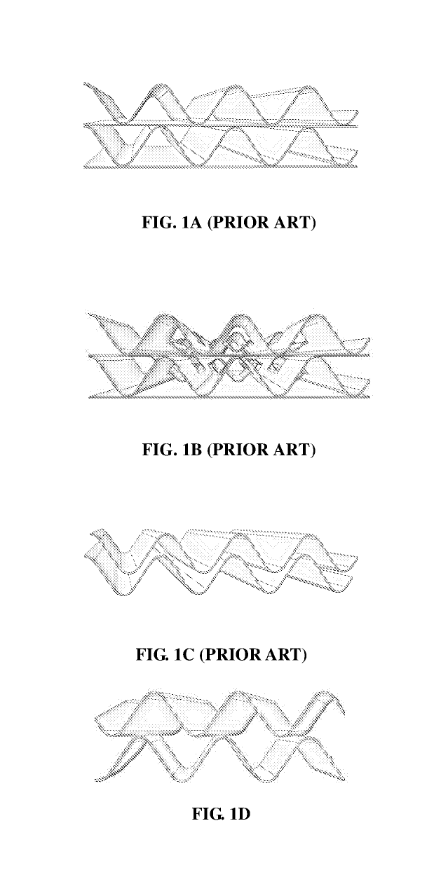

The winding, coiling or folding of present corrugated metal foil with oblique angle corrugation results in layers where the corrugation is “unaligned” or “not in alignment” between each layer. For example, each layer may have oblique angle corrugation that is opposite the previous and/or next layer. See for instance FIG. 1D. The layers having unaligned corrugation results in skewed (not straight) channels.

“Common”, or common substrate, as used herein, refers to previously known and used prior art substrates.

Advantageously, the present matrices do not contain secluding foils. Secluding foils are for example flat foils, flat foils with etch-hole or micro-ripple foils. Secluding foils may be defined as any additional foil between a corrugated foil.

The oblique angle corrugation provides a turbulent flow in cells created by the fused layers of the metal foil strip.

“Plurality” means two or more. For example, 3 or more, 4 or more, 5 or more, 6 or more, 7 or more, 8 or more, 9 or more or 10 or more.

The metal foil strip can be a metal or metal alloy. The metal or metal alloy may be for example “ferritic” stainless steel such as that described in U.S. Pat. No. 4,414,023. An example of a suitable ferritic stainless steel alloy contains about 20% chromium, about 5% aluminum and from about 0.002% to about 0.05% of at least one rare earth metal selected from cerium, lanthanum, neodymium, yttrium and praseodymium or a mixture of two or more of such rare earth metals, balance iron and trace steel making impurities, by weight. A ferritic stainless steel is commercially available from Allegheny Ludlum Steel Co. under the trade designation ALFA IV.

Another usable commercially available stainless steel metal alloy is identified as Haynes 214 alloy. This alloy and other useful nickeliferous alloys are described for example in U.S. Pat. No. 4,671,931. These alloys are characterized by high resistance to oxidation and high temperatures. A specific example contains about 75% nickel, about 16% chromium, about 4.5% aluminum, about 3% iron, optionally trace amounts of one or more rare earth metals except yttrium, about 0.05% carbon and steel making impurities, by weight. Haynes 230 alloy, also useful herein has a composition containing about 22% chromium, about 14% tungsten, about 2% molybdenum, about 0.10% carbon, a trace amount of lanthanum, balance nickel, by weight.

The ferritic stainless steels and the Haynes alloys 214 and 230, all of which are considered to be stainless steels, are examples of high temperature resistive, oxidation resistant (or corrosion resistant) metal alloys that are useful for use in making the skewed channel matrices and substrates of the present invention.

Suitable metal alloys for use in this invention should be able to withstand “high” temperatures, e.g., from about 900° C. to about 1200° C. (about 1652° F. to about 2012° F.) over prolonged periods.

Other high temperature resistive, oxidation resistant metal alloys are known and may be suitable. For most applications, and particularly automotive applications, these alloys are used as “thin” metal or foil, that is, having a thickness of from about 0.001″ to about 0.005″ for example from about 0.0015″ to about 0.0037″.

The metal foil strip can be pre-coated after it has been corrugated, but before assembly into a skewed channel matrix or substrate. The metal foil strip can also be coated after assembly into a honeycomb body, such as by dip coating, for example. The coating may comprise a catalyst support material, such as a refractory metal oxide, e.g., alumina, alumina/ceria, titania, titania/alumina, silica, zirconia, etc., and if desired, a catalyst may be supported on the refractory metal oxide coating. For use in catalytic converters, the catalyst may comprise a platinum group metal (PGM), e.g., platinum, palladium, rhodium, ruthenium, indium, or a mixture of two or more of such metals, e.g., platinum/rhodium. The refractory metal oxide coating is generally applied in an amount ranging from about 5 mgs/square inch to about 200 mgs/square inch. The catalyst can also be coated directly onto the metal foil strip. A coating containing a catalyst is a catalytic coating.

The metal foil strip can have perforations. In some embodiments, a metal foil strip having perforations/cells of about 2 to about 30 cpsi can be used to produce the skewed channel substrate. Alternatively, the metal foil strip can be devoid of perforations.

The oblique angle corrugation can be straight or curvilinear. The two or more layers may be fused together by brazing. The skewed channel substrate may further comprise a catalyst, for example a catalytic coating.

FIG. 1A (reference) shows a common substrate design with secluding foils. FIG. 1B (reference) shows a mutation of a common design also with secluding foils. FIG. 1C (reference) shows another common design which fails to form channels without any secluding foils. FIG. 1D shows the inventive skewed channel matrix without any secluding foils and with channels that can provide turbulent flow.

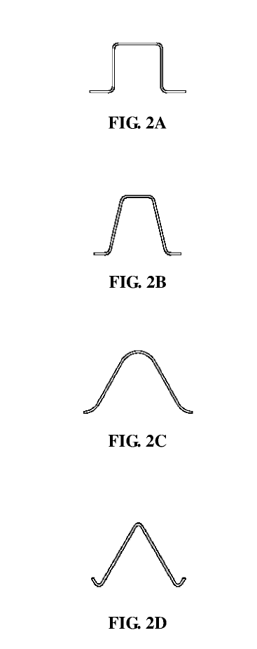

In some embodiments, the shape/angle of the oblique angle (i.e., non-straight channel) corrugation may be, but are not limited to, the shapes shown in FIGS. 2A, 2B, 2C, 2D, and combinations thereof.

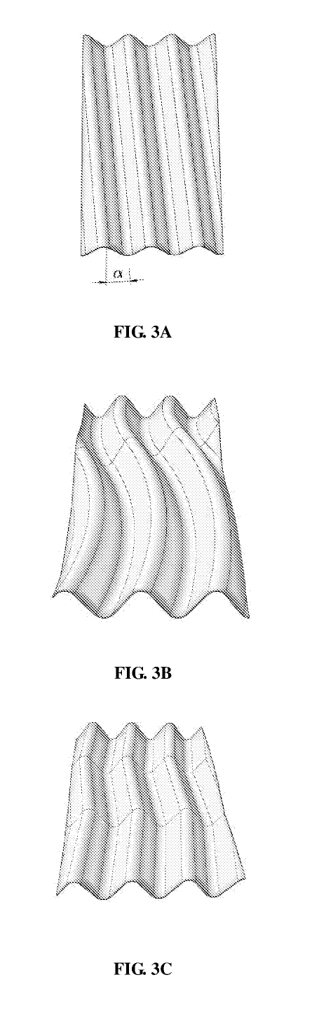

In other embodiments, the shape/angle of the oblique angle (i.e., non-straight channel) corrugation can be, but are not limited to, the shapes shown in FIGS. 3A, 3B and 3C. In this invention, the corrugated foils with oblique angle corrugation are wound (not folded) while the periphery foils mostly retain their shape. The various layers of the spiral wound structure are joined together by, for example, by brazing.

According to the substrates and matrices of this invention, turbulent flow in the cells of the substrates and matrices may provide a higher catalytic conversion rate than laminar flow. Further, the substrates and matrices of this invention provide branched road channels that can create increased turbulent flow compared to straight through channels. Additionally, the substrates and matrices of this invention comprise skewed channels that can create a high density of branched road channels that allow for improved emission flow.

The substrates and matrices of this invention can be made via the present methods with up to 40% less foil consumption while exhibiting improved durability and excellent catalytic activity.

### EXAMPLES

In the examples below, the performance of two types of substrates is compared. The skewed substrate is prepared as follows.

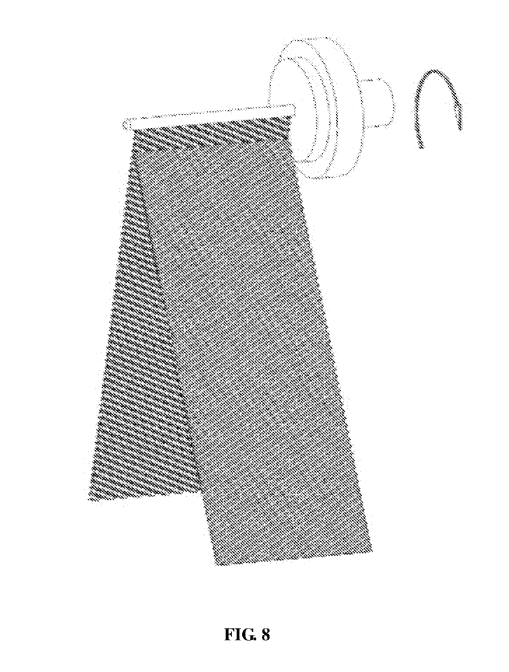

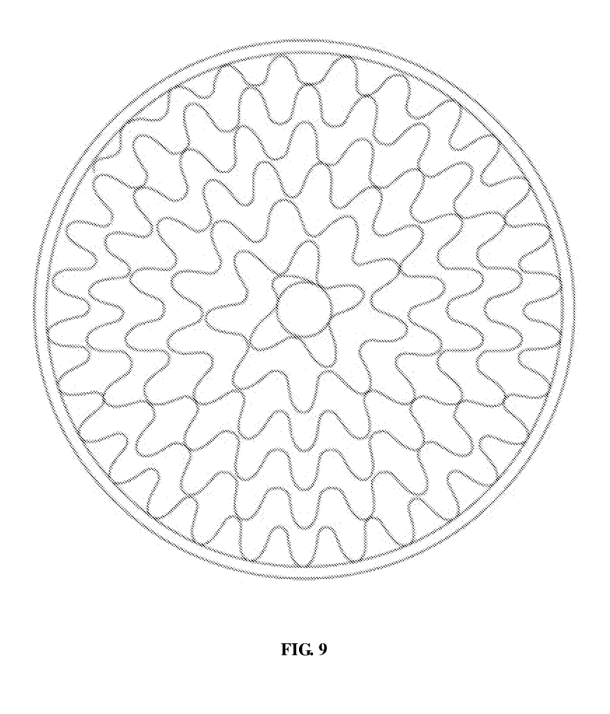

Corrugated foils are prepared with gears to have a wave section as shown in FIG. 2C. The gear pinion racks are oblique to the axis (not straight), so that they make foils with oblique angle (not straight) channel corrugation as shown in FIG. 3A. There is no need for secluding foils (e.g., flat foils, flat foils with etch-hole or micro-ripple foils). The corrugated foil is wound as a cylinder matrix such that each layer has an oblique angle opposite to the directly adjacent layers thereby forming a matrix with staggered and interflow channels. During this procedure, brazing material is deposited at the appropriate points. After winding (see FIG. 8), the skewed substrate is inserted into the mantle tube (see FIG. 9), and placed inside a vacuum brazing furnace to implement the brazing procedure.

The other substrate labeled as “common” is a commercially available straight channel substrate. The common substrate in this case means that honeycomb channels are formed by both corrugated foils and secluding foils (see FIG. 1A and FIG. 1B). The common substrates can be purchased from suppliers including but not limited to Emitec Gesellschaft für Emissionstechnologie mbH, Nippon Steel & Sumitomo Metal Corporation or BASF Corporation. In the present examples, the common substrate samples are made by BASF Catalysts (Guilin) Co., Ltd.

### Example 1

Substrates are tested for carbon monoxide (CO), hydrocarbons (HC) and nitrogen oxides (NOx) conversion according to the Euro III test procedure/HJ150 test motorcycle. Substrates have a diameter of 40 mm and a length of 90 mm, 300 cpsi (cells per square inch) a foil thickness of 0.05 mm of DIN 1.4767 alloy. The substrates have a catalytic coating of Pt/Pd/Rh 2/9/1 with a total PGM loading of loading 45 g/ft³. The present skewed channel substrate employs 47% less foil by weight than the common substrate. Nevertheless, the present substrate performs better than the common substrate.

| | CO | HC | NOx |
|---|---|---|---|
| substrate | conversion % | conversion % | conversion % |
| common | 71.2 | 55.6 | 68.9 |
| skewed channel | 72.7 | 56.6 | 72.7 |

### Example 2

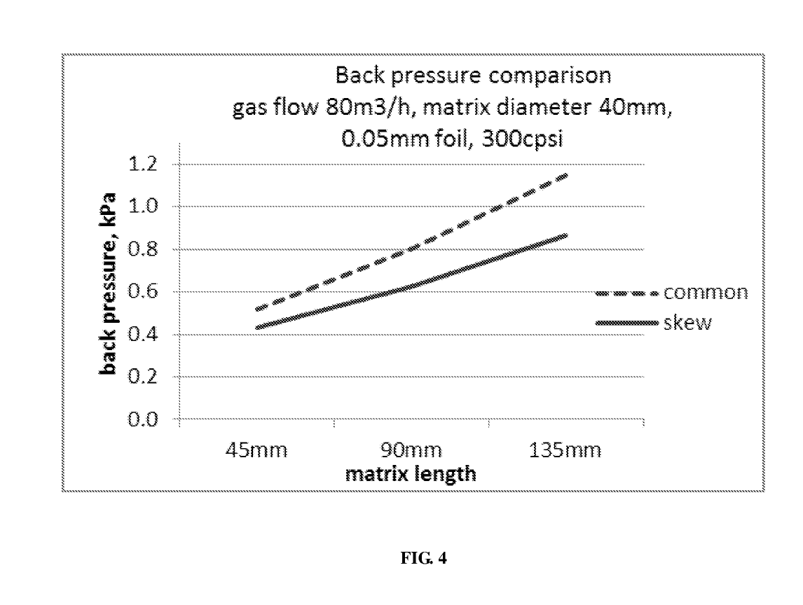

FIG. 4 shows a skewed channel substrate has less back pressure than the common. The air passes through the substrates (common and skew) and the fluid resistance caused by the channel walls and cell section area leads to the air flow velocity change and air pressure increase. The air flow pressure's change is called “back pressure” and this parameter is used to measure the performance of the common and skewed substrates.

### Example 3

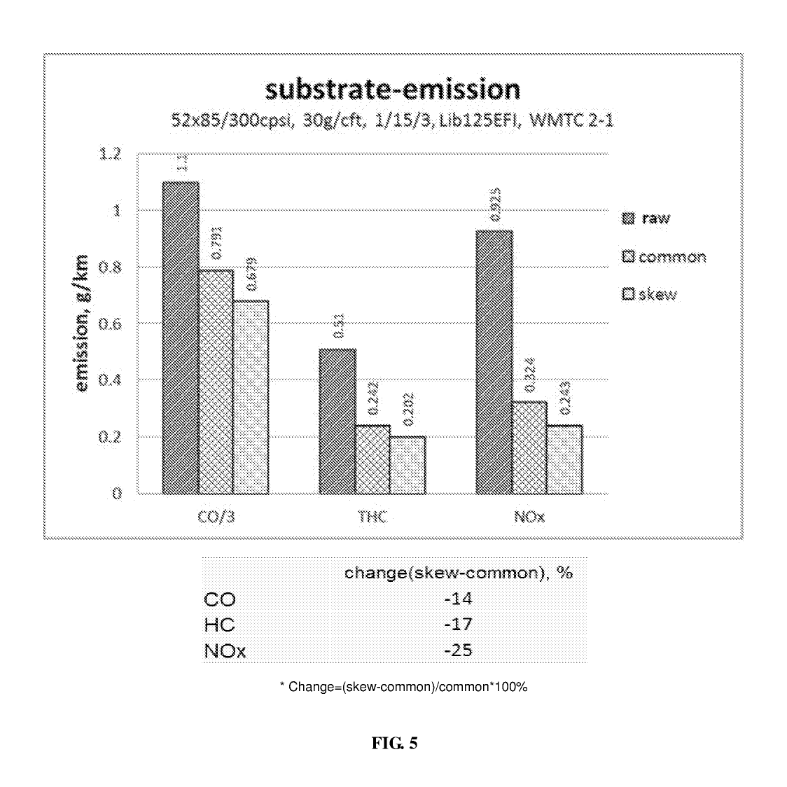

FIG. 5 shows that after being coated with a catalytic coating with the same PGM loading and ratio, same size skewed channel substrate catalyst has higher conversion or less emission than the common, likely due to its turbulent flow effect.

The common substrate and the skewed substrate in FIG. 5 have the same size, 52 mm by 85 mm, 300 cpsi, same catalyst PGM Pt/Pd/Rh (1/15/3) at same loading 30 g/cft. Substrates with catalytic coatings are assembled into a muffler in a test motorcycle and are tested according to the world motorcycle test cycle, WMTC2-1 on Lib 125cc with EFI system. “Raw” has no substrate or catalyst.

### Example 4

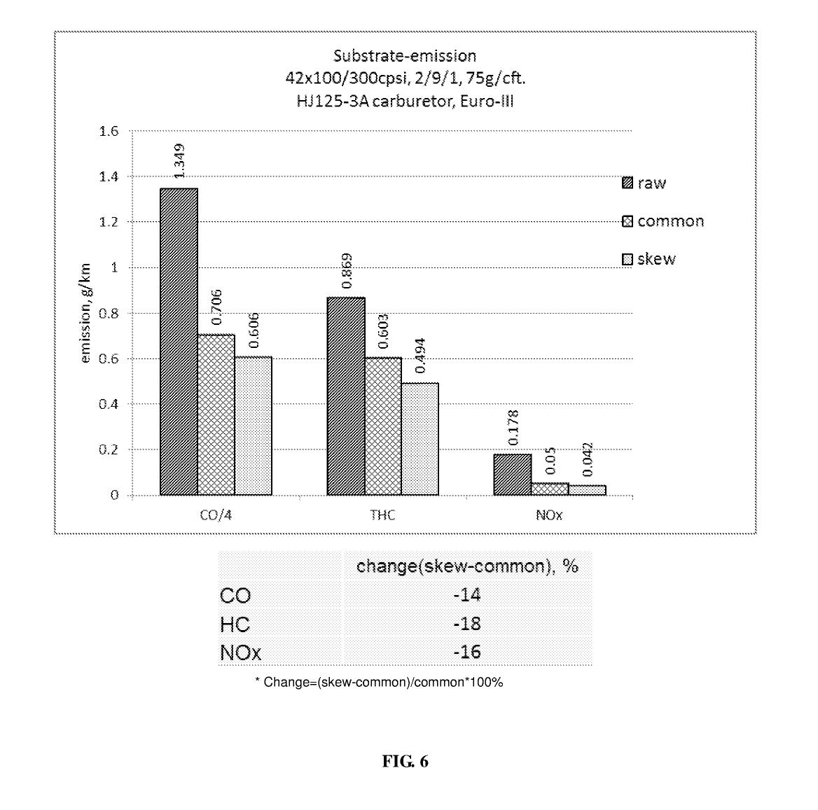

FIG. 6 shows that skewed channel substrate catalyst has higher conversion or less emission than the common, likely due to its turbulent flow effect. The common and the skewed in FIG. 6 have the same size, 42 mm by 100 mm, 300 cpsi, same catalyst Pt/Pd/Rh (2/9/1) at same loading 75 g/cft. Substrates with catalytic coatings are assembled into a muffler in a test motorcycle with HJ124-3A carburetor according to test cycle Euro-Ill. “Raw” has no substrate or catalyst.

### Example 5

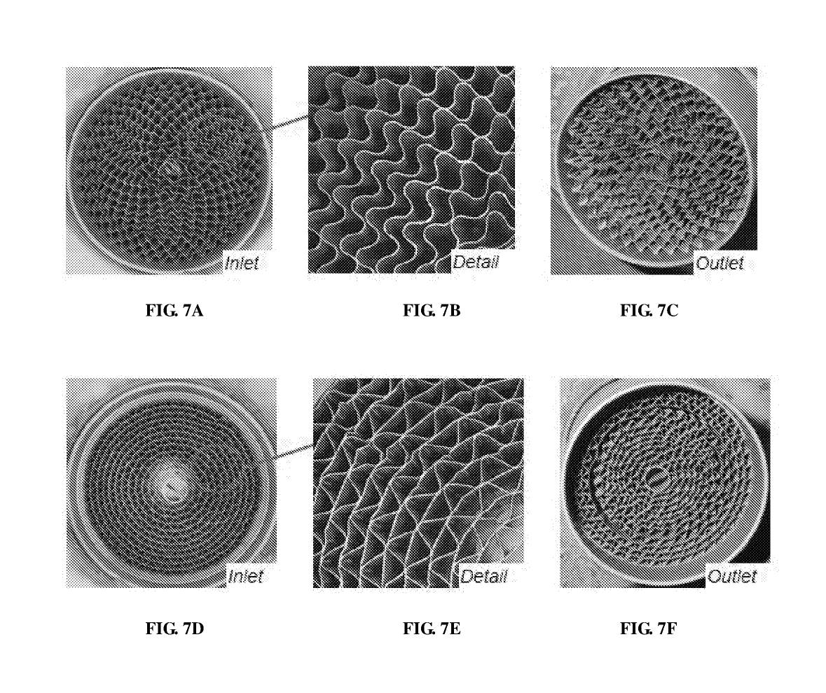

A present substrate and a common substrate are subjected to temperatures of 200 to 900° C. at a rate of 5000-6000 K/min, cycle time 210 sec/cycle and a cool down rate of 2000-3000 K/min. FIGS. 7A-7F show that after a hot cycling test, no deformation or breakage is found in the inventive skewed channel substrate, however some broken foil and matrix deformation are found in the common substrate. The figures show the skewed channel substrate of the present invention is more mechanically durable than a common substrate.

Although this invention has been described here in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

Unless otherwise indicated, all parts and percentages are by weight. Weight percent (wt %), if not otherwise indicated, is based on an entire composition free of any volatiles, that is, based on dry solids content.

All U.S. patent applications, published patent applications and patents referred to herein are hereby incorporated by reference.

1-14. (canceled)

15. A metal foil matrix comprising a plurality of metal foil layers each having oblique angle corrugation.

16. The matrix according to claim 15, wherein each layer has oblique angle corrugation that is not in alignment with the previous and/or next layer.

17. The matrix according to claim 15, wherein the layers are fused together.

18. The matrix according to claim 15, wherein the matrix does not contain secluding foils.

19. The matrix according to claim 15, wherein the oblique angle corrugation is adapted to provide turbulent gas flow.

20. The matrix according to claim 15, wherein the metal foil layers are perforated.

21. The matrix according to claim 15, wherein the metal foil layers are devoid of perforations.

22. The matrix according to claim 15, wherein the oblique angle corrugation is straight.

23. The matrix according to claim 15, wherein the oblique angle corrugation is curvilinear.

24. The matrix according to claim 15, further comprising a catalytic coating thereon.

25. A catalyst substrate comprising a jacket tube and the matrix according to claim 24 in an interior thereof.

26. A method of producing a catalyst substrate, the method comprising:
(a) providing a metal foil strip with oblique angle corrugation;
(b) winding, coiling, or folding the metal foil strip to form a matrix comprising a plurality of metal foil layers;
(c) inserting the matrix into a jacket tube; and
(d) joining a periphery of the matrix to the jacket tube interior.

27. The method according to claim 26, further comprising fusing the layers together after step (b).

28. The method according to claim 27, where the joining and/or fusing comprises brazing.
